(19) United States
(12) Patent Application Publication
(10) Pub. No.: US 2003/0015274 A1
(43) Pub. Date: Jan. 23, 2003

(54) Reflective hood for heat-shrinking film onto an open-topped container and method of using same

(76) Inventors: A. James Mallman, New Berlin, WI (US); Larry A. Gunseor, New Glarus, WI (US); Scott I. Biba, Luana, IA (US); Robert J. Aloisi, Kaukauna, WI (US)

Correspondence Address: Finnegan, Henderson, Farabow,, Garrett & Dunner, L.L.P., 1300 I Street, N.W., Washington, DC, 20005-3315, US

(21) Appl. No.: 10/183,416

(22) Filed: Jun. 28, 2002

Related U.S. Application Data
(60) Provisional application No. 60/302,313, filed on Jun. 29, 2001.

(51) Int. Cl. B65B 7/00; B32B 31/24; B31F 5/04; B27G 11/02

(52) U.S. Cl. 156/69; 156/85; 156/272.2; 156/379.6

(57) ABSTRACT

A reflective hood system for heat-shrinking a film onto an open-topped container includes a radiant energy source located above the mouth of the container, and a reflective hood which serves to concentrate the energy from the a radiant energy source located above the mouth of the container and redirect energy radially inwardly onto the area of the film which is to be shrunk. A reflective hood system may also include a reflective shield located at or near an opening in the reflective hood above the mouth of the container.

### FIELD OF THE INVENTION

This invention pertains to an apparatus and method for heat shrinking thin film onto an open-topped container, such as a cup. In particular, this invention pertains to an apparatus and method for heat shrinking a film onto an open-topped container including a reflective hood and optical element assembly for directing radiant energy to a specific area.

### BACKGROUND OF THE INVENTION

Presently, in the fast food drink industry, it is typical to serve a drink in a paper, plastic, or other disposable cup topped with a preformed plastic lid. The plastic lid fits relatively tightly over the brim formed at the top of, for example, a paper drink cup, and may include apertures to permit straws or openings to be formed in the lid to allow one to directly drink the contents of the cup without removing the lid.

Unfortunately, there are many problems associated with the use of these plastic lids. For example, the lids are bulky and create problems in storage and in disposal. Still further, the seal formed by the lids is dependent upon the lid being placed on properly, and can leak if not properly placed.

In order to overcome these problems, various devices and methods have been proposed in which a cover is placed on an open-topped container and then heated to shrink it into sealing engagement with the top of such a container. These prior art devices and methods, however, fail to provide a sufficiently cost efficient, easy, and inexpensive alternative to preformed rigid plastic lids. As a consequence, rigid plastic lids remain in widespread use.

Some of the main failings of these prior devices are that they are bulky, noisy, unresponsive, and expensive. Heating systems comprising blowing air over a hot element and then onto a film require large amounts of unnecessary heat, even when in standby mode, which makes temperature control very difficult. Further, continuous elevated temperatures are expensive to maintain and may be undesirable to the immediate environment.

An improvement to these prior art systems is found in a device described in U.S. Pat. No. 5,249,410, incorporated herein by reference, which uses heat shrinkable film lids having annular energy absorbent regions formed thereon, preferably by application of an energy absorbent ink such as by printing. In this device for shrinking thin film over a container to form a lid, multiple radiant energy sources are utilized. The primary radiant energy source is located closely adjacent to the lip of the cup and moves peripherally around the lid while a secondary radiant energy source is stationed over the cup. When the primary energy source is activated, energy falling upon the energy absorbent region in the film causes the film to shrink, preferentially in the area around the lip of the cup, while energy from the secondary energy source may serve to tauten up the central portion of the lid. Alternatively, multiple primary radiant energy sources can be located around the periphery of the mouth of the cup. The apparatus disclosed in the '410 patent does not detail an efficient method of concentrating and redirecting energy toward the region of the film which is to be shrunk. In other arrangements, multiple energy sources at fixed locations, are provided.

In another arrangement of the above improvement, the radiant energy source includes multiple sources rotating around the circumference of the container. In still further arrangements, multiple energy sources at fixed locations, as well as fixed annular radiant energy sources, are provided.

In each of the above, the primary radiant energy source is located in close proximity to the area of film on which energy absorption is desired to shrink the film. These methods are not particularly efficient in directing the radiant energy to areas of the film which are to be shrunk. Accordingly, the above described structures suffer from disadvantages. For example, an unnecessary amount of heat is generated in the lid area, leading to potential heating of the contents of the cup. In addition, in those structures where moving parts are necessary, additional maintenance requirements generally follow. Further, a substantial amount of energy is wasted as it is not directed to the area where shrinkage is desired, leading to a slower sealing process and/or higher energy requirements.

The present invention addresses these problems by providing a reflective hood which directs the radiant energy to the areas where shrinkage is desired. Thus, the lidding time is reduced because the energy is more efficiently delivered to the shrinkage area as compared to lidding systems having multiple rotating or fixed sources, also resulting in a reduction in the amount of heat generated. In a preferred embodiment, light from a light source above the cup mouth is redirected and concentrated to fall on the area of the film adjacent to the lip of the cup.

Further advantages of the invention will be set forth in part in the description which follows and in part will be apparent from the description or may be learned by practice of the invention. The advantages of the invention may be realized and attained by means of the instrumentalities and combinations particularly pointed out in the appended claims.

### SUMMARY OF THE INVENTION

As embodied and broadly described herein, the invention includes a reflective hood system for heat-shrinking a film onto an open-topped container comprising a radiant energy source located above the mouth of the container, and a reflective hood which serves to concentrate the energy from the radiant energy source located above the mouth of the container and redirect a portion of the energy radially inwardly onto the area of the film which is to be shrunk.

According to one embodiment, a reflective shield will be located at or near an opening in the reflective hood above the mouth of the container. In another embodiment of the present invention, the reflective hood will take the form of a shell, preferably a curvilinear shell. In still another embodiment, the curvilinear shell will have a surface of revolution. In yet another embodiment, the reflective hood as a double ellipsoidal shape, as hereinafter defined.

In another embodiment of the present invention, the invention includes a method of heat-shrinking film onto an open-topped container comprising the steps of contacting the top of an open-topped container with a heat shrink material, placing the covered open-topped container at an opening of a reflective hood, wherein a portion of the opening of the reflective hood is covered by a reflective shield, and activating a radiant energy source, the radiant energy source, preferably emitting radiant energy, wherein a first portion of the radiant energy reflects along a surface of the reflective hood and is ultimately directed to an area below the brim of the open-topped container, thereby shrinking the heat-shrink film and wherein, the portion of the heat-shrink film located under the reflective shield is substantially free of impingement by the first portion of radiant energy. Further, in the method of the present invention, a second portion of the radiant energy reflects off a surface of the reflective shield and impinges on a surface of the reflective hood and is ultimately directed to an area below the brim of the open-topped container, thereby shrinking the heat-shrink film, and, wherein the portion of the heat-shrink film located under the reflective shield is substantially free of inpingement by the second portion of radiant energy. Moreover, the method of the present invention includes providing a protective optical element at the opening in the reflective hood. The protective optical element should be any material that will allow sufficient radiant energy to pass therethrough, for example, glass or plastic. In one embodiment, the method of the present invention includes providing a reflective hood having a curvilinear surface of revolution, where the reflective hood can be a double ellipsoidal hood.

The accompanying drawings, which are incorporated herein and constitute a part of this specification, illustrate an embodiment of the invention, and, together with the description, serve to explain the principles of the invention.

### BRIEF DESCRIPTION OF THE DRAWINGS

FIG. 1 illustrates a reflective hood according to a first embodiment of the present invention.

FIG. 2 illustrates a reflective hood according to a second embodiment of the present invention.

FIG. 3 illustrates a reflective hood according to a third embodiment of the present invention.

### DESCRIPTION

Reference will now be made in detail to the present preferred embodiments of the invention, examples of which are illustrated in the accompanying drawings. While the following description is directed to open-topped containers, such as cups, those of ordinary skill in the art will appreciate that the invention is equally applicable to other open-topped containers, such as food cartons.

In accordance with the invention, as broadly described, the reflective hood system includes an energy source, a reflective hood, an optional reflective shield, and a protective optical element. In general, the radiant energy source emits radiant energy preferably as visible and near infrared radiation. A portion of the emitted radiant energy contacts the surface of the reflective hood until finally being directed toward a thin energy-absorbing film that will shrink when impinged on by visible and near infrared radiation. A portion of the remaining radiant energy is reflected by the reflective shield and is directed back to the reflective hood and to the thin film.

In the present invention, film is provided covering the top of, and extending downwardly past the brim of, an open-topped container, such as a drinking cup. The radiant energy from the radiant energy source is directed to the area just below the periphery of the top of the cup, i.e., just below the brim.

Thus, the radiant energy causes the film to shrink in the area around the brim, thereby forming a lid. The film is preferably a bi-axially oriented thin shrink film having a preferred thickness of between 40 to 120 gauge (1.02 mm to 3.05 mm), with a more preferred film having a thickness of between 60 to 100 gauge (1.52 mm to 2.54 mm). One film that has been used is a 75 gauge (1.91 mm) DuPont Clysar ABL polyolefin shrink film. Appropriate shrink film would be readily apparent to the skilled artisan. Any art recognized film would be appropriate, such as 75 gauge (1.91 mm) Intertape Exfilm polyolefin shrink film. When used to cover food products, the film should be food contact-approved by the appropriate regulatory authorities.

To ensure that the film sufficiently shrinks when contacted by radiant energy, it is generally desired for the film to be coated with a radiant energy absorbing substance. One such substance that works well in this environment is carbon black pigment. Other substances that would achieve satisfactory results include graphite and iron oxide. According to one embodiment of the present invention, the carbon black pigment may be included as a functional component in ink that is applied to the surface of the film.

In another embodiment of the present invention, at least two ink layers are applied to the film. One layer is a reflective layer and the second layer is a radiant energy absorbing layer. The radiant energy absorbing layer preferably contains an energy absorbing substance, such as carbon black, which increases the shrink rate of the film. The reflective layer acts as a reflector and reflects some of the radiant energy that passes through the energy absorbing layer back to the energy absorbing layer, thereby increasing the amount of energy absorbed by the energy absorbing layer.

Ink systems that have been found to be adequate for use with the current invention are described below. Those of ordinary skill in the art will understand that there are a variety of ink systems, having one or more ink layers, that can be used with the present invention.

According to one embodiment, in a two layer ink system, the film may include a white ink, i.e., reflective layer, and a maroon ink, i.e., energy absorbing layer. In a preferred energy absorbing layer, carbon black is mixed into the maroon layer. To enhance shrinkage of the film, it is preferred that carbon black be added at a concentration of at least approximately 6% by dry weight of the ink formulation. In addition, it is preferred that at least 0.03 lbs. of carbon black be added to every 3000 sq. ft. of printed area of the film. Those of ordinary skill in the art will understand that a variety of ink concentrations can achieve satisfactory results in the present invention. The white layer acts as a reflector so that the radiant energy that passes through the maroon layer will be reflected back towards the maroon layer, thereby enhancing impingement of the maroon layer by the radiant energy. While the invention has been described in terms of a white or maroon layer, those of ordinary skill in the art will appreciate that a variety of colors can be used to achieve a reflective layer and an energy absorbing layer.

In another two layer ink system, the film is coated with an aluminum particulate silver ink and then a blue or black ink, preferably with a substantial amount of a material which is highly energy absorbent for the particular energy source being utilized, such as carbon black. As with the white layer described above, the silver layer acts as a reflector so that the radiant energy that passes through the blue layer will be reflected back towards the blue layer, thereby enhancing impingement of the blue layer by the radiant energy.

A four layer ink system is preferred when lighter, more decorative, colors are desired on the top surface of the film. In particular, it is sometimes desired to apply a decorative layer above the absorbent layer. In one embodiment of a four layer ink system, the four layer ink system has a film, silver reflective layer, an absorbent layer, a white reflective layer, and a decorative layer, The decorative layer may contain multiple colors that are lighter than the maroon and dark blue generally achieved with two layer systems. The decorative layer may also contain advertising slogans and indicia useful for identifying the contents of the lidded container. Those of ordinary skill in the art will understand that a variety of layer color combinations can be used to achieve the results of the present invention.

Each of the above formulations is acceptable for use with the current invention. The four layer ink system provides acceptable film shrink and superior appearance. The two color system achieves acceptable film shrink and appearance at a lower cost.

Those of ordinary skill in the art will understand that the desirable number of ink layers used can depend on a variety of factors, e.g., cost. In addition, those of ordinary skill in the art will understand that it is not necessary to coat the entire film with ink. In particular, in those area where shrinkage is not desired, the ink coating need not be applied and may, in fact, be undesirable. Moreover, those of ordinary skill in the art will appreciate that ink patterns can be used on any ink layer.

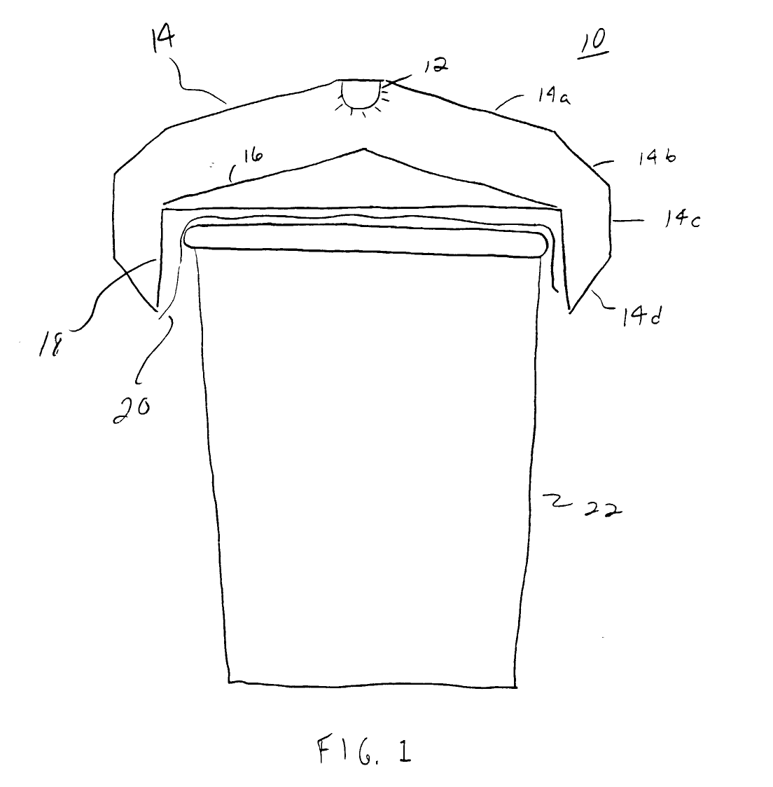

According to one embodiment of the invention, and as shown in FIG. 1, the reflective hood assembly 10 includes a radiant energy source 12, a reflective hood 14, a reflective shield 16, and a protective element 18. The protective element 18 may be any art recognized or after developed material. The protective element may be glass, plastic, or other material that allows sufficient amounts of radiant energy to pass therethrough. The radiant energy source 12 produces radiant energy for shrinking a film 20 by emitting radiant energy having wavelengths in the visible and near infrared range. Those of ordinary skill in the art will understand that the wavelength of the energy emitted by the radiant energy source is not particularly critical so long as the ink chosen is sufficiently absorbent over a range of the wavelengths emitted that film shrinkage is reasonably rapid. Of course, care must be taken to insure that the surfaces serving as reflectors are actually reflective for radiation in the chosen wavelengths if radiation outside the visible range is emitted.

In particular, a convenient radiant energy source 12 is a conventional halogen lamp emitting light energy having wavelengths at least between approximately 600-1400 nm. It has been found that tungsten halogen lamps are a preferred radiant energy source 12, however, those of ordinary skill in the art will understand that a number of different radiant energy sources are available which produce sufficient visible and near infrared radiation, such as xenon arc lamps. The energy source is preferred to have a wattage of between 150-1000 watts for compatibility with standard electrical wiring/circuiting.

The reflective hood 14 reflects the radiant energy emitted from the radiant energy source 12 and directs it to the area where film shrinkage is desired, i.e., the target area. The reflective hood 14 depicted in FIG. 1 is constructed of a series of frusto-conical surfaces 14a-14d located at angles with respect to each other forming a reflector which is generally concave downward.

In operation, as radiant energy impinges on one of the surfaces 14a-14c it will be reflected such that it either directly, or through a series of reflections, impinges on the lowermost surface 14d. The lower most reflection surface 14d is shaped to cause the radiant energy to reflect from the surface and impinge on the desired shrinkage area. The inner surface of the reflective hood 14 may have a smooth, mirror-like surface to aid in reflecting the radiant energy. Moreover, the inner surface may have a metallized silver-coated or gold-coated mirrored surface to reduce reflection losses. Those of ordinary skill in the art will understand that there are a variety of surfaces and coatings that can be used to reflect radiant energy. In addition, those of ordinary skill in the art will understand that similar results can be achieved using different numbers of surfaces and shapes.

The reflective shield 16 is a cover that substantially prevents radiant energy from contacting certain areas of the film 20 located over the mouth of the cup, keeping those areas free from shrinking. In addition, the reflective shield reflects the radiant energy, directing it back to the reflective hood 14, where it is eventually directed to the target area. The reflective shield 16 may be shaped to form an opposing side to the curve-shaped reflective hood 14 so as to optimize reflection of the radiant energy. For instance, as shown in FIG. 1, it is desired that the radiant energy generally not contact the area of the film 20 covering the open portion of the container 22. Accordingly, the reflective shield is positioned over the top of the film 20 to prevent the radiant energy from contacting the film positioned over the open portion of the beverage container 22. In some applications, energy may be intentionally directed to certain areas over the mouth of the container to cause selective shrinking, as an aid in, for example, forming apertures for straws. The reflective shield 16 should be constructed to prevent visible and near-infrared radiant energy from penetrating through the shield 16. The reflective shield 16 preferably has a metallized surface that reflects radiant energy as discussed above. Further, the reflective shield 16 preferably has a metallic mirrored surface to more efficiently reflect the radiant energy. Thus, when the radiant energy source 12 emits radiant energy, some of the radiant energy is directed to the area covered by the reflective shield 16.

This radiant energy reflects off the reflective shield 16, contacts the reflective hood 14, and is directed through a reflection, or a series of reflections, to the target area.

In one embodiment, the radiant energy source 12, reflective hood 14, and reflective shield 16 are protected by a protective optical element 18, although the apparatus will function without the optical element 18 in place. The protective optical element 18 prevents liquids from contacting the radiant energy source 12, the reflective hood 14, and the reflective shield 16.

In operation, the beverage container 22 is filled with a liquid beverage, such as water, soda, carbonated or non-carbonated, or coffee. During the lidding operation, described below, liquid could potentially splash onto parts of the reflective hood assembly 10, such as the radiant energy source 12, reflective hood 14, or reflective shield 16, causing damage or reducing efficiency.

The protective optical element 18 is preferably integral with the reflective hood assembly 10. The protective optical element 18 should be constructed of materials that minimize loss of radiant energy allowing sufficient radiant energy to pass through and contact the film. It is preferred that the protective optical element 18 be constructed of plastic, or more preferably, of glass. Those of ordinary skill in the art will understand that a variety of materials can be used to construct the protective optical element 18.

The lidding operation of the described apparatus will now be explained. After the beverage container 22 is filled with the desired beverage, the operator places the beverage container 22 in contact with the film 20 and in proximity of the reflective hood assembly 10. As the beverage container 22 is placed into position, the radiant energy source 12 is activated, emitting radiant energy. The radiant energy emits diffusely in all directions contacting either the reflective hood 14 or the reflective shield 16. Through either one or a series of reflections, the radiant energy contacts the lowermost reflection surface 14d, which directs the radiant energy to the desired shrinkage area of the film 20 located around the brim of the beverage container 22. As the radiant energy contacts the film 20, radiant energy is absorbed and the film 20 shrinks, forming a seal around the lid of the beverage container 22. The lidded beverage container 22 is then removed from the reflective hood assembly 10.

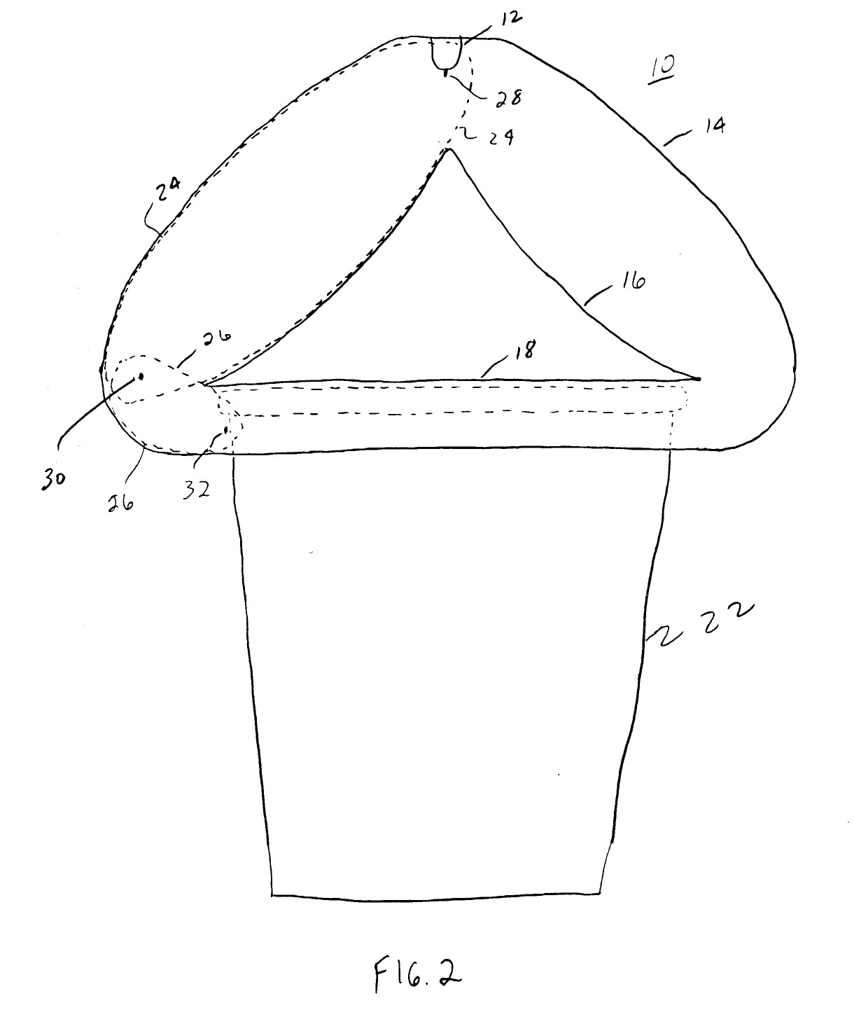

In another embodiment of the present invention, as shown in FIG. 2, a double ellipsoidal structure is formed by the curvatures of the reflective hood 14 and the reflective shield 16. The reflective hood assembly 10 has a double ellipsoidal structure that improves the efficiency in delivering the radiant energy to the target shrinkage area. The first or primary ellipsoid 24 is defined by the uppermost portion of the reflective hood 14 and the upper surface of the reflective shield 16. Unlike the reflective hood 14 depicted in FIG. 1, the reflective hood 14 has a largely curvilinear surface of revolution. The primary ellipsoid 24 has a focal point 28 and a focal ring 30. The focal point 28 is located coincident with the focal point of the radiant energy source 12, which is attached to the assembly 10 at the upper end of the primary ellipsoid 24 in the vicinity of the radiant energy source 12. The focal ring 30 is located at the lower end of the primary ellipsoid 24. In operation, the radiant energy emitted from the radiant energy source 12 passes from the focal point 28 and through the focal ring 30.

Because of the curvilinear surface of revolution of the reflective hood 14 wall, the majority of the radiant energy that does not flow directly from the focal point 28 through the focal ring 30, but instead contacts the reflective hood 14 or the reflective shield 16, will reflect off the reflective hood 14 or the reflective shield 16 and through the second focal ring 30.

The secondary ellipsoid 26 is defined by the lower portion of the reflective hood 14. The secondary ellipsoid 26 has two focal rings 30, 32. The lower portion of the reflective hood 14 is configured such that the focal ring 30 of the second ellipsoid ring is common with the first ellipsoid focal ring 30. Moreover, the lower portion of the reflective hood 14 is configured such that the second focal ring 32 of the secondary ellipsoid 26 is located near the shrinkage target area of the film 20. When the radiant energy passes through the secondary ellipsoid first focal ring 30, as described above, the radiant energy reflects off the surface of the reflective hood 14. Because of the curvilinear surface of revolution of the lower portion of the reflective hood 14, the radiant energy reflects off of the lower portion of the reflective hood 14 then passes through the secondary ellipsoid second focal ring 32 and impinges on the film 20 at the shrinkage target area. It is preferred that the shrinkage target area be located just below the brim of the opening of the beverage container 22, such that when the radiant energy contacts the film 20, a seal is formed below the lid of the beverage container 22.

The reflective shield 16 of this embodiment, which prevents radiant energy from impinging a portion or portions of the surface of the film 20, may be a curved reflective part of the first ellipsoidal 24 surface. The shape of the reflective shield 20, as shown in FIG. 2, is designed to reflect the radiant energy that contacts it such that the radiant energy passes through the focal ring 30. As noted above, it is preferred that the reflective shield have a metallic mirrored surface.

Those of ordinary skill in the art will readily understand how to determine the dimensions for a double ellipsoidal reflective hood for effectively directing the radiant energy to the target area. An example of the calculations for determining the dimensions are set forth in the following example.

The following equations can be used to determine the ellipsoids:

Major Axis (length of primary ellipsoid): 2a=2b+2c

Major Axis (length of secondary ellipsoid): 2d=2e+2f

where 2b,2e=the distance between the focal points of each ellipsoid; and

c,f=the distance from foci to the edge of the ellipse at the apex.

To determine the dimensions, the “c” distance (for the primary ellipse), which is dependent upon the size and shape of the radiant energy source being used, must be selected. In addition, the distance between the focal points of the large ellipse, “2b”, which is the distance needed for the largest cup, must be selected. After determining the desired energy profile at the cup, the following selections were made:

For the primary ellipse: c=0.2″ and 2b=5″

For the secondary ellipse: f=0.2 and 2e=1″

Using the above values, the dimensions of the ellipses were determined. Understanding that the primary and secondary ellipses share a common focal point, the secondary ellipse was rotated −25 degrees about the common focal point. Then, both the primary and secondary ellipses were rotated 45 degrees about the focal point coincident with the radiant energy source.

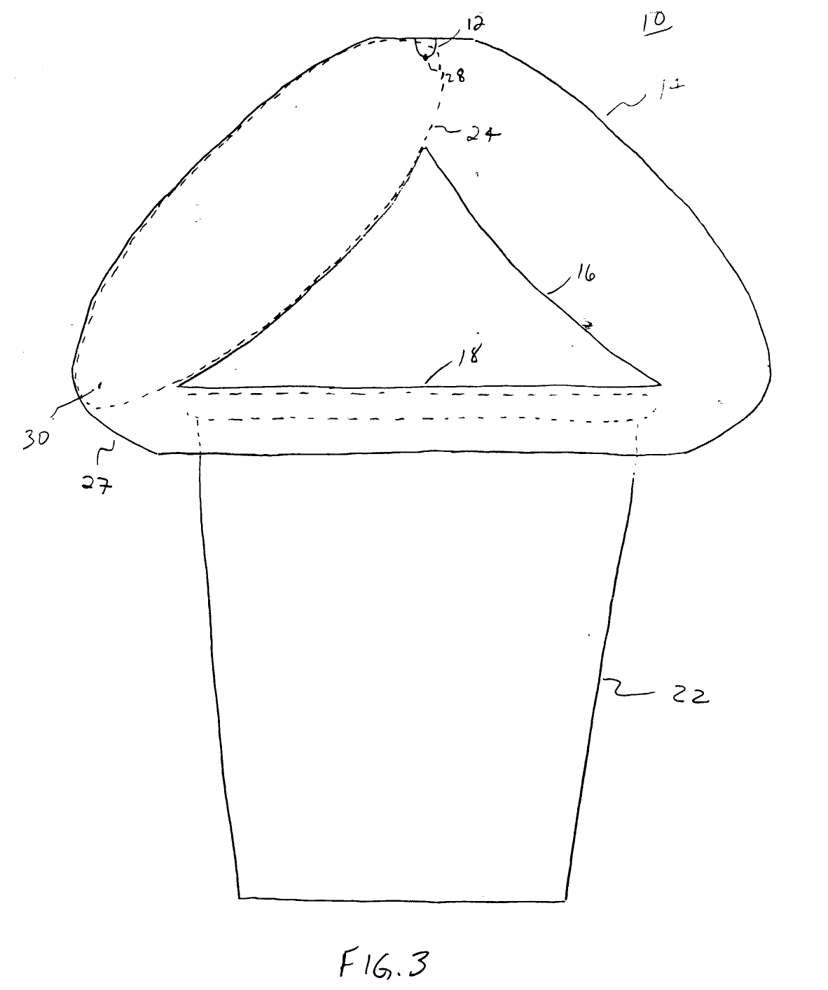

In another embodiment of the claimed invention, as depicted in FIG. 3, a single ellipsoidal/parabolic structure is formed by the curvatures of the reflective hood 14 and the reflective shield. The single ellipsoidal/parabolic structure improves the efficiency in delivering the radiant energy to the brim of the cup when multiple cup sizes are to be used. As compared to the double ellipsoidal structure described above, which directs the radiant energy such that it converges at a target area, the single ellipsoidal/parabolic structure directs the reflected radiant energy in a substantially horizontal band towards the target area.

As described in conjunction with the double ellipsoidal structure, the primary ellipsoid 24 is defined by the uppermost portion of the reflective hood 14 and the upper surface of the reflective shield 16. Unlike the reflective hood 14 depicted in FIG. 1, the reflective hood 14 has a largely curvilinear surface of revolution. The primary ellipsoid 24 has a focal point 28 and a focal ring 30. The focal point 28 is located coincident with the focal point of the radiant energy source 12, which is attached to the assembly 10 at the upper end of the primary ellipsoid 24 in the vicinity of the radiant energy source 12. The focal ring 30 is located at the lower end of the primary ellipsoid 24. In operation, the radiant energy emitted from the radiant energy source 12 passes from the focal point 28 and through the focal ring 30. Because of the curvilinear surface of revolution of the reflective hood 14 wall, the majority of the radiant energy that does not flow directly from the focal point 28 through the focal ring 30, but instead contacts the reflective hood 14 or the reflective shield 16, will reflect off the reflective hood 14 or the reflective shield 16 and through the second focal point 30.

Unlike the double ellipsoidal structure described above, however, the lower portion of the reflective hood 14 defines a parabaloid 27. The parabaloid 27 is defined by the lower portion of the reflective hood 14. The lower portion of the reflective hood 14 is configured such that when the radiant energy passes through the focal ring 30 of the primary ellipsoid, the radiant energy reflects off the surface of the reflective hood 14 in a direction substantially horizontal to the mouth of the open-topped container. As such, because the radiant energy contacts the lower portion of the reflective hood at various locations, and because the reflected radiant energy then travels substantially horizontally towards the cup, the reflected radiant energy does not converge to a common location as with the double ellipsoidal hood. Instead, the radiant energy travels in a band the width of the vertical height of the parabaloid. Therefore, regardless of the width of the cup, or its location underneath the reflective hood, the radiant energy should contact the brim of each sized cup in generally the same area.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A reflective hood system for heat-shrinking a film onto an open-topped container comprising:
a reflective hood having a reflective interior surface;
a radiant energy source; and
a reflective shield, the reflective hood and the reflective shield being configured to concentrate radiant energy from the radiant energy source about the periphery of an opening in a portion of the hood.

2. The reflective hood system according to claim 1 further comprising a protective optical element, wherein the protective optical element is provided at the opening in the reflective hood.

3. The reflective hood system according to claim 2 wherein the protective optical element is plastic.

4. The reflective hood system according to claim 2 wherein the protective optical element is glass.

5. The reflective hood system according to claim 1 wherein the interior surface is coated with a material to enhance surface reflectivity.

6. The reflective hood system according to claim 5 wherein the interior surface is coated with a gold or silver metallic reflective surface.

7. The reflective hood system according to claim 1 wherein the reflective hood comprises at least four angularly displaced frusto-conical surfaces.

8. The reflective hood system according to claim 7 wherein the interior surface is coated with a material to enhance surface reflectivity.

9. The reflective hood system according to claim 8 wherein the surfaces are coated with a gold or silver metallic reflective surface.

10. The reflective hood assembly according to claim 1 wherein the reflective hood has a curvilinear surface of revolution.

11. The reflective hood assembly according to claim 10 wherein the reflective hood is a double ellipsoidal hood.

12. The reflective hood system according to claim 11 wherein the interior surface is coated with a material to enhance surface reflectivity.

13. The reflective hood assembly according to claim 12 wherein a surface of the double ellipsoidal reflective hood is coated with a gold or silver metallic reflective surface.

14. The reflective hood assembly according to claim 10 wherein the double ellipsoidal reflective hood has first and second focal rings, and wherein one of the first or second focal rings is coincident with the periphery of the opening in the lower portion of the hood.

15. A method of heat-shrinking film onto an open-topped container comprising the steps of:
contacting the top of an opening of an open-topped container with a heat-shrink film;
placing the covered open-topped container at an opening of a reflective hood, wherein a portion of the opening of the reflective hood is covered by a reflective shield; and
subjecting the covered container to radiant energy.

16. The method according to claim 15 wherein a first portion of the radiant energy reflects along a surface of the reflective hood and is ultimately directed to an area below the brim of the open-topped container, thereby shrinking the heat-shrink film and wherein, the portion of the heat-shrink film located under the reflective shield is substantially free of impingement by the first portion of radiant energy.

17. The method according to claim 16 wherein a second portion of the radiant energy reflects off a surface of the reflective shield and contacts a surface of the reflective hood and is ultimately directed to an area below the brim of the open-topped container, thereby shrinking the heat-shrink film, and, wherein the portion of the heat-shrink film located under the reflective shield is substantially free of impingement by the second portion of radiant energy.

18. The method according to claim 15 wherein a protective optical element is provided at the opening in the reflective hood.

19. The method according to claim 18 wherein the protective optical element is plastic.

20. The method according to claim 18 wherein the protective optical element is glass.

21. The method according to claim 15 wherein the interior surface of FINNEGAN the reflective hood is coated with a material to enhance surface reflectivity.

22. The method according to claim 21 wherein the interior surface is coated with a material to enhance surface reflectivity.

23. The method according to claim 15 wherein the reflective hood comprises at least four angularly displaced frusto-conical surfaces.

24. The method according to claim 23 wherein the interior surfaces of the reflective hood are coated with a material to enhance surface reflectivity.

25. The method according to claim 23 wherein the surfaces are coated with a gold or silver metallic reflective surface.

26. The method according to claim 15 wherein the reflective hood has a curvilinear surface of revolution.

27. The method according to claim 26 wherein the reflective hood is a double ellipsoidal hood.

28. The method according to claim 27 wherein the interior surfaces of the reflective hood are coated with a material to enhance surface reflectivity.

29. The method according to claim 28 wherein a surface of the double ellipsoidal reflective hood is coated with a gold or silver metallic reflective surface.

30. The method according to claim 27 wherein the double ellipsoidal reflective hood has first and second focal rings, wherein one of the first or second focal rings is coincident with the periphery of the opening in the lower portion of the hood, and wherein the radiant energy is concentrated at the focal ring coincident with the periphery of the opening in the lower portion of the hood.

31. A reflective hood system for heat-shrinking a film onto an open-topped container comprising a reflective hood capable of concentrating energy from a radiant energy source onto an area of the film which is to be shrunk.

32. The reflective hood system according to claim 31 wherein the reflective hood has a reflective interior surface.

33. The reflective hood system according to claim 31 wherein the reflective hood includes a radiant energy source.

34. The reflective hood system according to claim 31 wherein the reflective hood includes a reflective shield, the reflective hood and the reflective shield being configured to concentrate radiant energy from the radiant energy source about the periphery of an opening in a portion of the hood.

35. The reflective hood system according to claim 31 further comprising a protective optical element, wherein the protective optical element is provided at the opening in the reflective hood.

36. The reflective hood system according to claim 35 wherein the protective optical element is plastic.

37. The reflective hood system according to claim 35 wherein the protective optical element is glass.

38. The reflective hood system according to claim 32 wherein the interior surface is coated with a material to enhance surface reflectivity.

39. The reflective hood system according to claim 38 wherein the interior surface is coated with a gold or silver metallic reflective surface.

40. The reflective hood system according to claim 32 wherein the reflective hood comprises at least four angularly displaced frusto-conical surfaces.

41. The reflective hood system according to claim 40 wherein the interior surface is coated with a material to enhance surface reflectivity.

42. The reflective hood system according to claim 41 wherein the surfaces are coated with a gold or silver metallic reflective surface.

43. The reflective hood assembly according to claim 32 wherein the reflective hood has a curvilinear surface of revolution.

44. The reflective hood assembly according to claim 43 wherein the reflective hood is a double ellipsoidal hood.

45. The reflective hood system according to claim 44 wherein the interior surface is coated with a material to enhance surface reflectivity.

46. The reflective hood assembly according to claim 45 wherein a surface of the double ellipsoidal reflective hood is coated with a gold or silver metallic reflective surface.

47. The reflective hood assembly according to claim 44 wherein the double ellipsoidal reflective hood has first and second focal rings, and wherein one of the first or second focal rings is coincident with the periphery of the opening in the lower portion of the hood.

48. A method of heat-shrinking film onto an open-topped container comprising the steps of: contacting the top of an opening of an open-topped container with a heat-shrink film;
placing the covered open-topped container at an opening of a reflective hood; and
concentrating energy from a radiant energy source onto an area of the film which is to be shrunk.

49. The method according to claim 48 wherein a first portion of the radiant energy reflects along a surface of the reflective hood and is ultimately directed to an area below the brim of the open-topped container, thereby shrinking the heat-shrink film.

50. The method according to claim 49 wherein a second portion of the radiant energy reflects off a surface of the reflective shield and contacts a surface of the reflective hood and is ultimately directed to an area below the brim of the open-topped container, thereby shrinking the heat-shrink film.

51. The method according to claim 48 wherein a protective optical element is provided at the opening in the reflective hood.

52. The method according to claim 51 wherein the protective optical HENDERSON element is plastic.

53. The method according to claim 51 wherein the protective optical element is glass.

54. The method according to claim 48 wherein the interior surface of the reflective hood is coated with a material to enhance surface reflectivity.

55. The method according to claim 54 wherein the interior surface is coated with a material to enhance surface reflectivity.

56. The method according to claim 48 wherein the reflective hood comprises at least four angularly displaced frusto-conical surfaces.

57. The method according to claim 56 wherein the interior surfaces of the reflective hood are coated with a material to enhance surface reflectivity.

58. The method according to claim 57 wherein the surfaces are coated with a gold or silver metallic reflective surface.

59. The method according to claim 48 wherein the reflective hood has a curvilinear surface of revolution.

60. The method according to claim 59 wherein the reflective hood is a double ellipsoidal hood.

61. The method according to claim 60 wherein the interior surfaces of the reflective hood are coated with a material to enhance surface reflectivity.

62. The method according to claim 61 wherein a surface of the double ellipsoidal reflective hood is coated with a gold or silver metallic reflective surface.

63. The method according to claim 60 wherein the double ellipsoidal reflective hood has first and second focal rings, wherein one of the first or second focal rings is coincident with the periphery of the opening in the lower portion of the hood, and wherein the radiant energy is concentrated at the focal ring coincident with the periphery of the opening in the lower portion of the hood.

64. The method according to claim 15 wherein the radiant energy has visible and near infrared wavelengths.

65. The reflective hood according to claim 32 having an upper portion and a lower portion wherein the upper portion defines an ellipsoid and the lower portion defines a parabaloid.

66. The reflective hood assembly according to claim 65 wherein the upper portion of the reflective hood has first and second focal rings, and wherein one of the first or second focal rings is coincident with the periphery of the opening in the lower portion of the hood.
